(19) United States
(12) Patent Application Publication
(10) Pub. No.: US 2008/0132376 A1
(43) Pub. Date: Jun. 5, 2008

(54) Power transmission device

(75) Inventor: Steven James Simmons, Leonard, MI (US)

Correspondence Address: MITCHELL M. MUSIAL II, PLLC, 6960 ABBOTT TERRACE, WEST BLOOMFIELD, MI, 48323, US

(73) Assignee: SJS Choppers, LLC

(21) Appl. No.: 11/607,727

(22) Filed: Nov. 30, 2006

(51) Int. Cl. F16H 3/00

(52) U.S. Cl. 475/298

(57) ABSTRACT

Disclosed herein is a power transmission device for providing torque in a reverse direction and forward direction and for use in a vehicle having a power source. The device employs a pair of bevel gears slidably disposed on an output shaft to permit selective engagement of a forward or reverse direction of the output shaft.

### FIELD OF THE INVENTION

The present invention relates to a power transmission device providing torque in a reverse direction and forward direction and for use in a vehicle having a power source. More specifically, the present invention relates to a power transmission device for providing a reverse torque for a vehicle having a continuously variable transmission driven by means of a belt.

### BACKGROUND OF THE INVENTION

Vehicles such as snowmobiles and three wheeled motor vehicles commonly called “trikes” typically employ an electric motor to provide reverse torque. In the case of a snowmobile, the torque is applied to the belt, or in the case of the trike, to one or both rear wheels. As weight and size are typical limitations to vehicles of this nature, the electric motor is typically underpowered and the electrochemical storage device is limited in storage capacity. In instances where significant demands are made for reverse torque, it is foreseeable that either insufficient torque is produced to move the vehicle or the electrical power source may be depleted, or both.

One solution for providing reverse torque for a snowmobile is disclosed in U.S. Pat. No. 4,502,353 to Beaudoin. The '353 patent discloses a planetary gear assembly coupled to the output shaft of a continuously variable transmission via a dog clutch. A shift mechanism, operable by a control member, causes engagement and disengagement of the planetary gear support and transmission member to cause alternate forward and reverse drives as well as idling of the driving shaft. A pawl is used to stop the rotation of the planetary gear support and reverse the output shaft direction.

Another solution for providing reverse torque for an ATV is disclosed in U.S. Pat. No. 4,497,220 to Grinde. The '220 patent discloses a planetary gear system having primary and secondary planetary gears slidably mounted in a slidable differential housing and partially meshed with respective input and output gears. Forward drive is achieved in each of a plurality of forward drive ranges by the respective coupling of the primary planet gears with the secondary planet gears and output gear and the secondary planet gears with the input gear. Reverse drive is achieved for each of the forward ranges via the coupling of the input gear only with the secondary planet gears and the output gear only with the primary planet gears, while restraining rotation of the differential housing.

Additionally, U.S. Pat. No. 7,063,639 to Schoenfelder, et al. discloses the use of a planetary gear arrangement to obtain a reverse gear. The forward/reverse planetary unit disclosed includes a first planetary assembly and a second planetary assembly. First and second bands are employed to selectively lock the planetary sets.

All of the aforementioned systems for providing a reverse gear employ the use of one or more planetary gear arrangements. A significantly more simple, lower cost solution would be advantageous. Therefore, there is a need in the art for a non-planetary gear arrangement that may provide a reverse gear for trikes, snowmobiles, and the like.

### SUMMARY OF THE INVENTION

A power transmission device for transferring torque in a reverse direction or forward direction, where the device is used in a vehicle having a power source, comprises a housing and an input shaft rotatably supported by the housing and driven by the power source and rotatable about an input rotary axis. An input gear is fixedly attached to the input shaft. At least one output shaft is rotatably supported in the housing, where the output shaft is rotatable about an output rotary axis. A selectively engageable first side gear and a selectively engageable second side gear are translatably coupled to the output shaft and are translatable along the output rotary axis relative to the output shaft. An engagement means is provided for selectively engaging the first side gear to the input gear for driving the output shaft in a first rotational direction about the output rotary axis for establishing one of a forward mode or reverse mode, and the engagement means is further operable for selectively engaging the second side gear to the input gear for driving the output shaft in a rotational direction about the output rotary axis opposite the first rotational direction for establishing the other of a forward mode or reverse mode.

In one embodiment, the power transmission device has engagement means that comprises a cam system including a first pair of cams and a second pair of cams, the cam system operable for causing the first pair of cams to be in a gear engagement state while the second pair of cams are in a gear disengagement state. The cams are pivotable about an axis, having a flat portion and a lobe portion, whereby the cams are operable to pivot from a gear engagement state where the cam lobe is in a high position, causing one of the first side gear or said second side gear to be in contact with the input gear, to a gear disengagement state where the cam lobe is in a low position, causing one of the first side gear or said second side gear to be disengaged from the input gear.

The power transmission device may also include a mode selection module that includes a set of cam gears engaging a timing gear, where each of the cam gears are operatively coupled to a cam. The timing gear is pivotable from a first position where the cam gears cause the cams to command a forward mode to a second position where the cam gears cause the cams to command a reverse mode.

The power transmission device may include engagement means selected from the group consisting of a pivotal cam system, a ball ramp system, a hydraulic actuator, an electromagnetic actuator and a ball screw actuator.

The engagement means simultaneously engages one of either the first side gear or second side gear to the input gear while disengaging the other of either the first side gear or second side gear from the input gear.

The output shaft includes a first slot and second slot formed therethrough, each having a key disposed therethrough with sufficient clearance to permit the key to translate within the respective slot along the output rotary axis of the output shaft. Each key couples one of the first side gear and second side gear to the output shaft, permitting the first side gear and second side gear to be translatably coupled to the output shaft.

The first side gear and second side gear may be translatably coupled to the output shaft by a slidably engageable coupling, where the coupling is selected from the group consisting of a translatable key, splines, and threads. Additionally, the first side gear and second side gear have a disengaged default bias.

In an alternate embodiment, the power transmission device comprises a first output shaft and a second output shaft rotatably supported in the housing, where the first and second output shafts are rotatable about an output rotary axis. A selectively engageable first side gear is translatably coupled to the first output shaft. A selectively engageable second side gear translatably coupled to said second output shaft. The first side gear is translatable along the output rotary axis relative to the first output shaft and the second side gear is translatable along the output rotary axis relative to the second output shaft.

Further objects, features and advantages of the present invention will become apparent to those skilled in the art from analysis of the following written description, the accompanying drawings and the appended claims.

### BRIEF DESCRIPTION OF THE DRAWINGS

FIG. 1 is an environmental view of a powertrain including an engine, a CVT and a power transmission device of the present invention in a snowmobile;

FIG. 2 is a top view of the power transmission device of the present invention having the top cover removed to reveal the operative elements therein;

FIG. 3A is a partial top view of the power transmission device of the present invention as shown in FIG. 2, enlarged to reveal a side gear disengaged from the input gear;

FIG. 3b is a plan view of a cam according to one embodiment of the present invention;

FIG. 4A is an illustration of a mode selection module according to the principals of the present invention, revealing a plurality of cam gears engaged with a timing gear;

FIG. 4B is a plan view of a mode selection module according to the principals of the present invention, shown mounted on the housing and the cam gears engaged with the timing gear while the lever in a first position;

FIG. 4C is a perspective view of the mode selection module as shown in FIG. 4B, showing a cam gear partially removed to reveal the cam and cam gear interface;

FIG. 5 is a partial top view of the power transmission device of the present invention as shown in FIG. 2, enlarged to reveal a first side gear engaged with the input gear;

FIG. 6 is a perspective view of an output shaft having a slot 60 formed therethrough; and

FIG. 7 is a front view of the power transmission device of the present invention shown with the case disposed adjacent to the housing in operational position, revealing the cam gears and the cams in phantom.

### DESCRIPTION OF THE PREFERRED EMBODIMENT

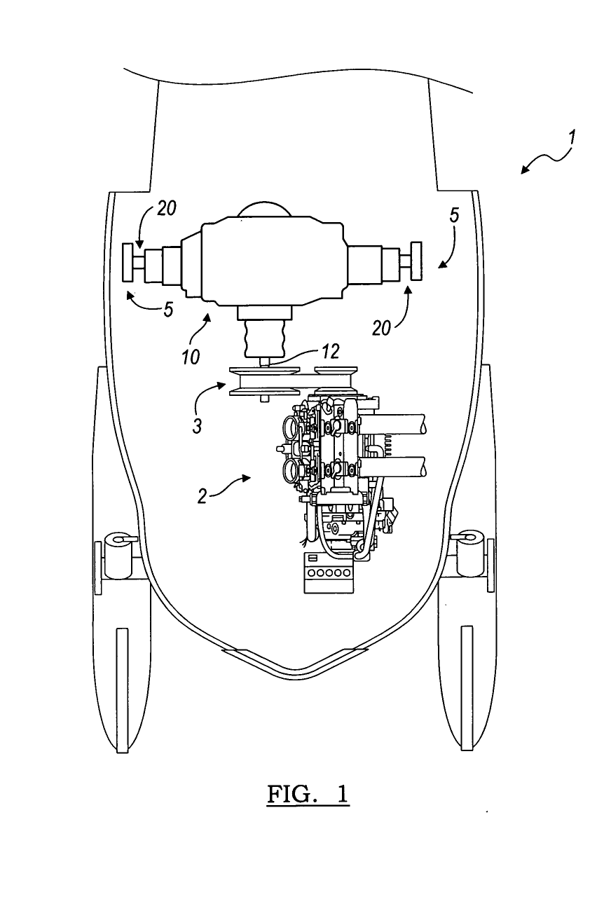

With initial reference to FIG. 1, an environmental view of a powertrain 7 including a longitudinally mounted engine 2, a continuously variable transmission (CVT) 3 and a power transmission device 10 of the present invention is shown in a snowmobile 1. Although the power source 2 is shown mounted longitudinally, it should be understood that it is contemplated to be within the scope of the present invention that other mounting arrangements, including transverse mounting of the engine 2, may be employed with the power transmission device 10 of the present invention.

Torque from the power source 2 is transferred through the CVT 3 via a belt 4 to input shaft 12. Torque from the input shaft 12 is transferred through the power transmission device 10 to one or more output shafts 20. The output shaft 20 has a pair of sprockets 5 that drive one track or pair of tracks (not shown) to propel the vehicle 1. Although the present invention is shown in particular exemplary embodiments, it should be understood that many alternatives as suggested herein are available to be employed with the power transmission device 10. The device 10 is shown in the environment of a snowmobile, it should understood that the device 10 may be employed in any powered vehicle that requires a reverse drive, including three and four wheeled vehicles.

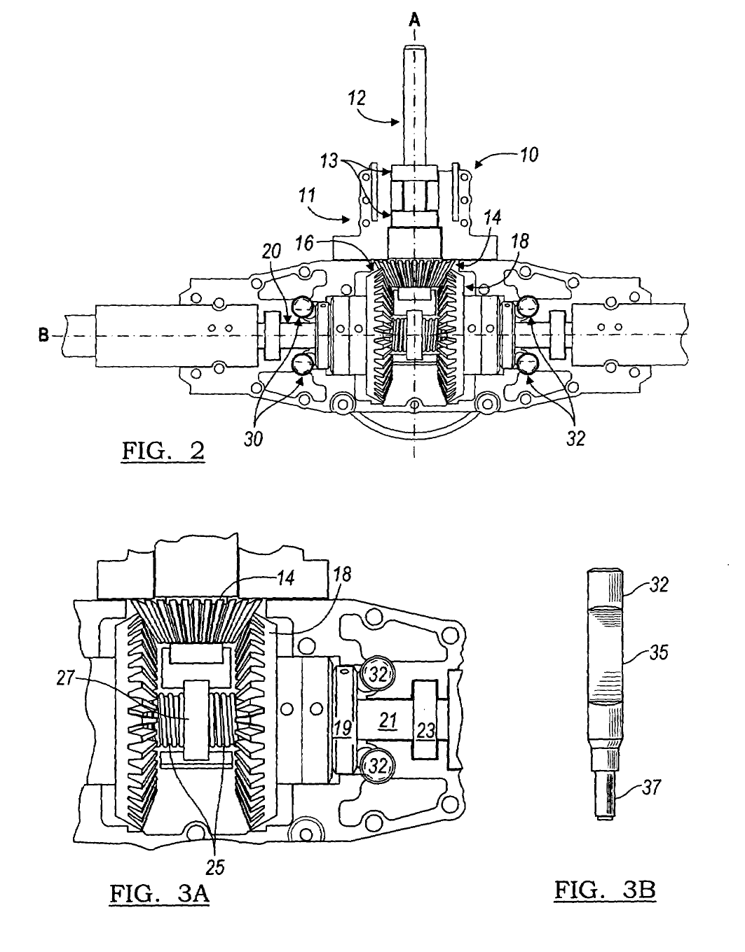

Referring now to FIG. 2 a top view of the power transmission device 10 of the present invention is shown having the top cover (not shown) removed to reveal the operative elements therein. The device 10 comprises a housing 11 and an input shaft 12 rotatably supported by a pair of bearings 13 in the housing 11. The input shaft 12 is rotatable about an input rotary axis A. An input gear 14 is fixedly attached to the input shaft 12. At least one output shaft 20 is rotatably supported in the housing 11 by a plurality of bearings. The output shaft 20 is rotatable about an output rotary axis B within sleeves 50, 52. A selectively engageable first side gear 16 and a selectively engageable second side gear 18 are translatably coupled to the output shaft 20 and are translatable along the output rotary axis B relative to the output shaft 20. As used herein, the term “translatably coupled” shall be understood to mean that the elements are rotationally coupled while permitting axial movement along the axis of the shaft. In the preferred embodiment the side gears 16, 18 are bevel gears.

In the preferred embodiment, the power transmission device has engagement means that comprises a cam system including a first pair of cams 30 and a second pair of cams 32, where the cam system is operable for causing the first pair of cams 30 to be in a gear engagement state while the second pair of cams 32 are in a gear disengagement state. The cams 30, 32 are pivotable about an axis, having a flat portion and a lobe portion, whereby the cams are operable to pivot from a gear engagement state where the cam lobe is in a high position, causing one of the first side gear 16 or said second side gear 18 to be in contact with the input gear 14, to a gear disengagement state where the cam lobe is in a low position, causing one of the first side gear 16 or said second side gear 18 to be disengaged from the input gear.

Alternatively, the power transmission device may include engagement means selected from the group consisting of a pivotal cam system, a ball ramp system, a hydraulic actuator, an electromagnetic actuator and a ball screw actuator. Any engagement means known in the art may be employed so long as the engagement means may urge the side gears 16, 18 toward the input gear 14.

The engagement means of the present embodiment of FIG. 2 for engaging the side gears 16, 18 is a set of cams 30, 32. A pair of cams 30 are disposed adjacent to a thrust bearing 17 in contact with first side gear 16 and a pair of cams 32 are disposed adjacent to a thrust bearing 19 in contact with second side gear 18. At least one spring 25 is disposed between side gears 16, 18 to provide a bias on the gears 17, 19 toward a disengaged state, whereby the gears 16, 18 are urged away from the gear 14 along the output rotary axis B, causing the cams 30, 32 to be in constant contact with the trust bearings 17, 19 respectively. The cams 30, 32 are pivotal about an axis to selectively engage one of the first side gear 16 or second side gear 18.

An engagement means 30, 32 is provided for selectively engaging the first side gear 16 to the input gear 14 for driving the output shaft 20 in a first rotational direction about the output rotary axis B for establishing one of a forward mode or reverse mode, and the engagement means 30, 32 is further operable for selectively engaging the second side gear 18 to the input gear 14 for driving the output shaft in a rotational direction about the output rotary axis B opposite the first rotational direction for establishing the other of a forward mode or reverse mode.

Referring now to FIG. 3A, a partial top view of the power transmission device 10 of the present invention, as shown in FIG. 2, is enlarged to reveal the second side gear 18 disengaged from the input gear 14. A second output shaft 21 is rotatably mounted in the case 11 supported by a thrust bearing 19 and a bearing 23 and extends through sleeve 52. Referring now also to FIG. 3b, a plan view of a cam 30, 32 is shown according to one embodiment of the present invention. The cam 30, 32 includes a cam lobe 35 and a key portion 37. A flat portion formed on the cam 30, 32 provides low lobe of the cam lobe 35. The cam 30, 32 pivots from a gear engagement state where the cam lobe is in a high position to a gear disengagement state where the cam lobe is in a low position. The cams 32 in FIG. 3A are shown pivoted where the cams 32 are in a low lobe position, as the flat portion of the cam lobe 35 is in contact with the thrust bearing 19, permitting the second side gear 18 to be in a disengaged state.

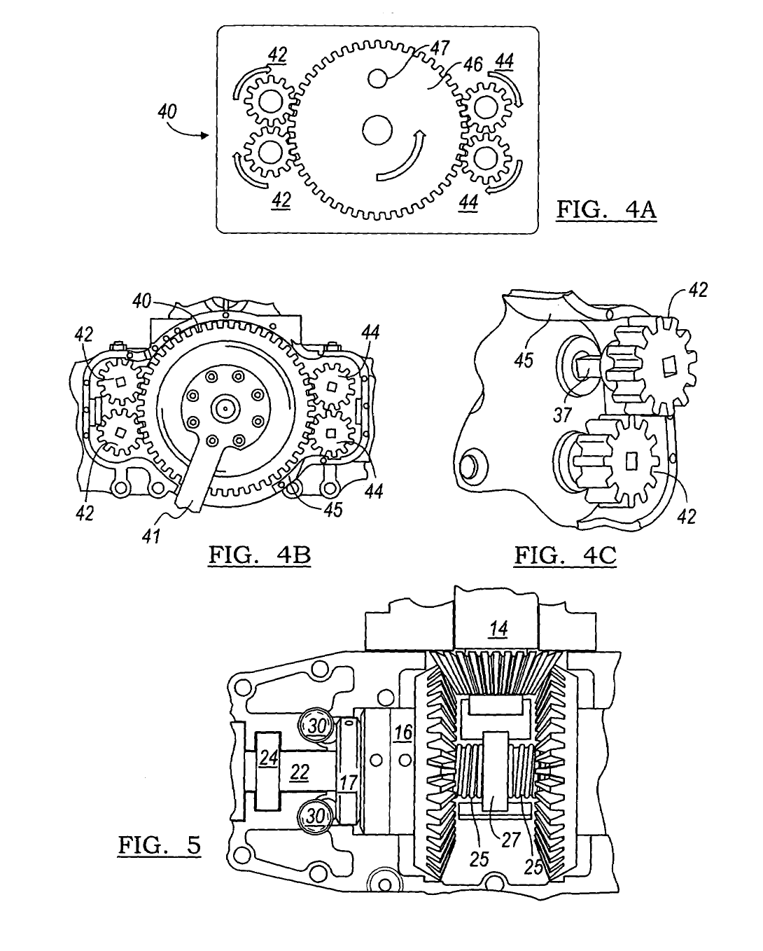

Referring now to FIG. 4A is an illustration of a mode selection module 40 according to the principals of the present invention is shown, revealing a plurality of cam gears 42, 44 engaged with a timing gear 46. A pin 47 is provided as a reference point on the timing gear 46. In the preferred embodiment, 47.8 degree of rotation of the timing gear 46 will result in 180 degrees of movement of the cam gears 42, 44, as a result of the gear ratio between the timing gear 46 and cam gears 42, 44. As the timing gear 46 is rotated counter clockwise, the cam gears 42, 44 simultaneously move clockwise. By employing a gear set to control the engagement of the side gears 16, 18, simultaneous engagement of the side gears is eliminated.

Referring now also to FIG. 4B, a plan view of a mode selection module 40 according to the principals of the present invention is shown, with the timing gear 46 meshed with cams gears 42, 44 and a lever 41 in a first position. A gear case 45 supports the cam gears 42, 44 which are keyed to the cams 30, 32 at the key portions 37. The case 45 is disposed adjacent to the housing 11. The cams 30,32 are pivotally supported in the case 45 and the housing 11. The lever 41 is located on the timing gear 46 by the pin 47. Each cam gear 42, 44 is keyed to a cam 30, 32. In the immediate embodiment, the lever 41 is moved from a first position, where one of the first side gear 16 and second side gear 18 are engaged, to a second position by 47.8 degrees, where the other of the first side gear 16 and second side gear 18 are engaged, the cam gears 42, 44, rotate 180 degrees simultaneously. Consequently, the cams 30, 32 which are keyed to the cam gears 42, 44, will rotate 180 degrees. Referring now to FIG. 4C a perspective view of the mode selection module 40 as shown in FIG. 4B is shown, revealing a cam gear 42 partially removed to reveal the cam 32 and cam gear 42 interface. The cam gears 42, 44 are precisely aligned so that at a first position one of the first side gear 16 and second side gear 18 are engaged while the other of the first side gear 16 and second side gear 18 are disengaged. The set of cam gears 42, 44 engage the timing gear 46, where each of the cam gears 42, 44 are operatively coupled to a cam 30, 32. The timing gear 46 is pivotable from a first position where the cam gears 42, 44 cause the cams 30, 32 to command a forward mode to a second position where the cam gears 42, 44 cause the cams 30, 32 to command a reverse mode.

Referring now to FIG. 5, a partial top view of the power transmission device 10 of the present invention of FIG. 2 is shown enlarged to reveal a first side gear 16 engaged with the input gear 14. The output shaft 20 is rotatably supported in the housing 11 by thrust bearing 17 and roller bearing 24. One or more center bearings 27 provide support for the shaft 20. The cams 30 are shown pivoted where the cam lobe 35 is in a high position, causing the thrust bearing 17 to urge the first side gear 16 into engagement with the input gear 14, overcoming the axial force exerted upon the first side gear 16 by the spring 25. Those skilled in the art will immediately recognize that as the second side gear 18 is engaged instead of the first side gear 16, the output shaft 20 will rotate in an opposite direction.

The first side gear 16 and second side gear 18 may be translatably coupled to the output shaft 20 by any slidably engageable coupling known in the art, such as a translatable key, splines, and threads. The side gears may be translatably coupled by any means known in the art so long as the gears may translate along the axis of the output shaft 20 while being rotatably coupled.

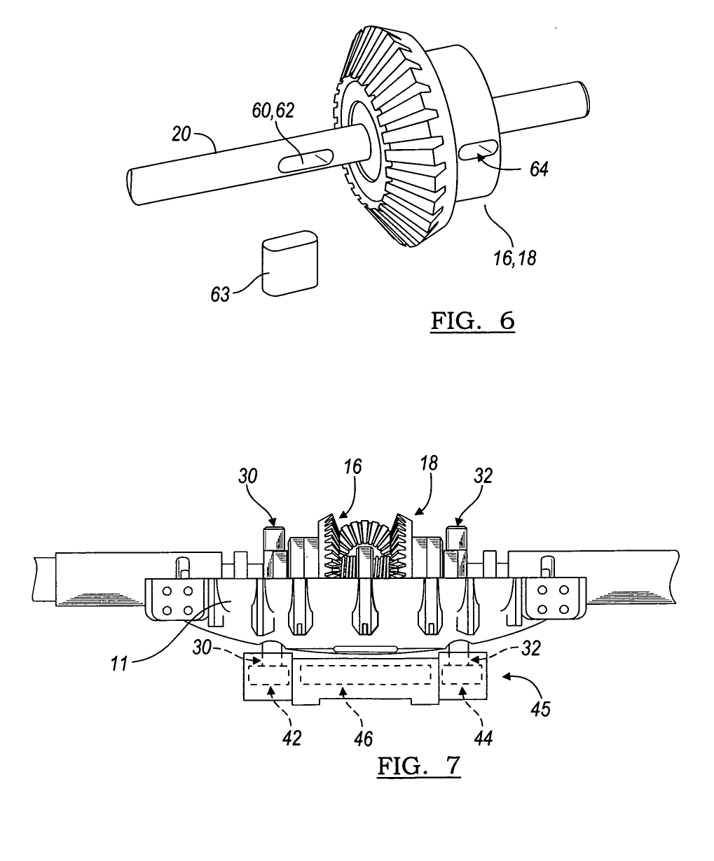

Referring now to FIG. 6, an output shaft is shown having a slot 60 formed therethrough. In the preferred embodiment, the output shaft 20 includes a first slot 60 and second slot 62 formed therethrough, if output shaft 20 a single output shaft. Alternatively, if the output shaft is a two piece shaft, each piece will have a slot 60 or 62. Each slot 60, 62, has a key 63 disposed therethrough. The slot 60, 62 is elongated yielding sufficient clearance to permit the key 63 to translate within the respective slot 60, 62 along the output rotary axis B of the output shaft 20. Each side gear 16, 18 has a keyway 64 located therein to receive a key 63. Each key 63 couples one of the first side gear 16 and second side gear 18 to the output shaft 20, permitting the first side gear 16 and second side gear 18 to be translatably coupled to the output shaft 20. In the present embodiment, a ⅜″ elongation of the slot 60, 62 with respect to the length of the key 63 is sufficient to provide adequate clearance to engage and disengage the side gears 16, 18.

Referring now also to FIG. 7, a front view of the power transmission device 10 of the present invention is shown with the case 45 disposed adjacent to the housing 11 in operational position, revealing the cam gears 42, 44 and the cams 30, 32 in phantom. The relationship between the cams 30, 32 and cam gears 42, 44 and the cams 30, 32 and the side gears 16, 18 can now be seen. As the cam gears 42, 44 rotate, the cams 30, 32 rotate as well, causing the side gears 16, 18 to translate. In operation, when the lever 41 is pivoted from a first position, the cam gears 42, 44 rotate the cams 30, 32, 180 degrees to cause one of either the first side gear 16 or second side gear 18 to engage the input gear 14 while disengaging the other of either the first side gear 16 or second side gear 18 from the input gear 14. A neutral position may also be obtained by locating the lever 41 at about midpoint between the first and second position.

The foregoing discussion discloses and describes the preferred structure and control system for the present invention. However, one skilled in the art will readily recognize from such discussion, and from the accompanying drawings and claims, that various changes, modifications and variations can be made therein without departing from the true spirit and fair scope of the invention as defined in the following claims.

What is claimed is:

1. A power transmission device for use in a vehicle having a power source, said transmission device for transferring torque in a reverse direction or forward direction, comprising:
a housing;
an input shaft rotatably supported by said housing and driven by the power source, said input shaft rotatable about an input rotary axis;
an input gear fixedly attached to said input shaft;
at least one output shaft rotatably supported in said housing, said output shaft rotatable about an output rotary axis;
a selectively engageable first side gear and a selectively engageable second side gear, said first side gear translatably coupled to said output shaft, said first side gear being translatable along the output rotary axis relative to said output shaft, said second side gear translatably coupled to said output shaft, said second side gear being translatable along the output rotary axis relative to said output shaft; and
engagement means for selectively engaging said first side gear to said input gear for driving said output shaft in a first rotational direction about the output rotary axis for establishing one of a forward mode or reverse mode, said engagement means is further operable for selectively engaging said second side gear to said input gear for driving said output shaft in a rotational direction about the output rotary axis opposite the first rotational direction for establishing the other of a forward mode or reverse mode.

2. The power transmission device as set forth in claim 1, wherein said engagement means is a cam system including a first pair of cams and a second pair of cams, said cam system operable for causing said first pair of cams to be in a gear engagement state while said second pair of cams are in a gear disengagement state.

3. The power transmission device as set forth in claim 2, wherein said cams are pivotable about an axis, said cams having a flat portion and a lobe portion, whereby said cams are operable to pivot from a gear engagement state where said cam lobe is in a high position, causing one of said first side gear or said second side gear to be in contact with said input gear, to a gear disengagement state where said cam lobe is in a low position, causing one of said first side gear or said second side gear to be disengaged from said input gear.

4. The power transmission device as set forth in claim 3, further comprising a mode selection module, said mode selection module including a set of cam gears engaging a timing gear, each of said cam gears being operatively coupled to a cam, said timing gear pivotable from a first position where said cam gears cause said cams to command a forward mode to a second position where said cam gears cause said cams to command a reverse mode.

5. The power transmission device as set forth in claim 1, wherein said engagement means is selected from the group consisting of a pivotal cam system, a ball ramp system, a hydraulic actuator, an electromagnetic actuator and a ball screw actuator.

6. The power transmission device as set forth in claim 1, wherein said engagement means simultaneously engages one of said first side gear or second side gear to said input gear while disengaging the other of said first side gear or second side gear from said input gear.

7. The power transmission device as set forth in claim 1, wherein said output shaft includes a first slot and second slot formed therethrough, each of said first slot and second slot having a key disposed therethrough with sufficient clearance to permit said key to translate along the output rotary axis of said output shaft, each said key coupling one of said first side gear and second side gear to said output shaft, whereby first side gear and second side gear are translatably coupled to said output shaft.

8. The power transmission device as set forth in claim 1, wherein said first side gear and second side gear are translatably coupled to said output shaft by a slidably engageable coupling, said coupling selected from the group consisting of a translatable key, splines, and threads.

9. The power transmission device as set forth in claim 1, wherein said first side gear and second side gear have a disengaged default bias.

10. A power transmission device for transferring torque in a reverse direction or forward direction, comprising:
a housing;
an input shaft rotatably supported by said housing and driven by the power source, said input shaft rotatable about an input rotary axis;
an input gear fixedly attached to said input shaft;
a first output shaft and a second output shaft rotatably supported in said housing, said first and second output shafts rotatable about an output rotary axis;
a selectively engageable first side gear and a selectively engageable second side gear, said first side gear translatably coupled to said first output shaft, said first side gear being translatable along the output rotary axis relative to said first output shaft, said second side gear translatably coupled to said second output shaft, said first side gear being translatable along the output rotary axis relative to said second output shaft; and
engagement means for selectively engaging said first side gear to said input gear for driving said first output shaft in a first rotational direction about the output rotary axis for establishing one of a forward mode or reverse mode, said engagement means is further operable for selectively engaging said second side gear to said input gear for driving said second output shaft in a rotational direction about the output rotary axis opposite the first rotational direction for establishing the other of a forward mode or reverse mode.

11. The power transmission device as set forth in claim 10, wherein said engagement means is a cam system including a first pair of cams and a second pair of cams, said cam system operable for causing said first pair of cams to be in a gear engagement state while said second pair of cams are in a gear disengagement state.

12. The power transmission device as set forth in claim 11, wherein said cams are pivotable about an axis, said cams having a flat portion and a lobe portion, whereby said cams are operable to pivot from a gear engagement state where said cam lobe is in a high position, causing one of said first side gear or said second side gear to be in contact with said input gear, to a gear disengagement state where said cam lobe is in a low position, causing one of said first side gear or said second side gear to be disengaged from said input gear.

13. The power transmission device as set forth in claim 12, further comprising a mode selection module, said mode selection module including a set of cam gears engaging a timing gear, each of said cam gears being operatively coupled to a cam, said timing gear pivotable from a first position where said cam gears cause said cams to command a forward mode to a second position where said cam gears cause said cams to command a reverse mode.

14. The power transmission device as set forth in claim 10, wherein said engagement means is selected from the group consisting of a pivotal cam system, a ball ramp system, a hydraulic actuator, an electromagnetic actuator and a ball screw actuator.

15. The power transmission device as set forth in claim 10, wherein said engagement means simultaneously engages one of said first side gear or second side gear to said input gear while disengaging the other of said first side gear or second side gear from said input gear.

16. The power transmission device as set forth in claim 10, wherein said first output shaft includes a first slot formed therethrough and said second output shaft includes and second slot formed therethrough, each of said first slot and second slot having a key disposed therethrough with sufficient clearance to permit said key to translate along the output rotary axis of each of said output shafts, each said key coupling one of said first side gear to said first output shaft and second side gear to said second output shaft, whereby first side gear is translatably coupled to said first output shaft and second side gear is translatably coupled to said second output shaft.

17. The power transmission device as set forth in claim 10, wherein said first side gear is translatably coupled to said first output shaft and second side gear is translatably coupled to said second output shaft by a slidably engageable coupling, said coupling selected from the group consisting of a translatable key, splines, and threads.

18. The power transmission device as set forth in claim 10, wherein said first side gear and second side gear have a disengaged default bias.
